(19) United States
(12) Patent Application Publication
(10) Pub. No.: US 2025/0369680 A1
(43) Pub. Date: Dec. 4, 2025

(54) SYSTEMS AND METHODS FOR PALLET RACKING SUPPORT

(71) Applicant: Level-Up Racking Co., Jacksonville, FL (US)

(72) Inventors: Josh Rouse, Jacksonville, FL (US); Michael Smith, Jacksonville, FL (US); Jason Fincher, Jacksonville, FL (US)

(21) Appl. No.: 18/676,088

(22) Filed: May 28, 2024

(51) Int. Cl. F25D 23/00; B65G 1/02; F25D 13/00

(52) U.S. Cl. CPC F25D 23/006; B65G 1/02; F25D 13/00

(57) ABSTRACT

A pallet racking support system is disclosed. The system can include refrigeration components located on a roof of a refrigerated facility. The system can include vertical components coupled to a floor and/or foundation of a refrigerated facility, where the vertical components extend through the roof of the refrigerated facility to couple to refrigeration components. The system can include horizontal components coupled to the vertical components, the vertical components and the horizontal components together forming storage spaces for receiving pallets. The system can include mounting brackets at the upper terminus of the vertical components for supporting the refrigeration components. The system can include thermal and moisture barriers applied to penetration regions between the refrigeration components and the roof.

### TECHNICAL FIELD

The present disclosure generally relates to systems and methods for pallet racking support for refrigerated facilities. In particular, the present disclosure relates to pallet racking support systems for use in refrigerated facilities, and methods for manufacturing and installing pallet racking support systems.

### BACKGROUND

Conventional pallet racking systems used in refrigerated warehouses can be installed to hold products stored on pallets. The pallets are placed and retrieved from the pallet racking systems using equipment such as fork-lifts. Refrigerated warehouses require large refrigeration systems that can include refrigeration equipment located on a roof of the refrigerated warehouses. Since these refrigeration equipment can have a substantial static load, a corresponding substantial structural reinforcement in the frame and roof of the refrigerated warehouse itself can be required.

The foregoing discussion, including the description of motivations for some embodiments of the invention, is intended to assist the reader in understanding the present disclosure, is not admitted to be prior art, and does not in any way limit the scope of any of the claims.

### SUMMARY

Systems and methods for a pallet racking support system are presented. In some embodiments, the system can include refrigeration components located on a roof of a refrigerated facility. In some examples, the system can include vertical components coupled to a floor and/or foundation of a refrigerated facility, where the vertical components extend through the roof of the refrigerated facility to couple to refrigeration components. The system can include horizontal components coupled to the vertical components, the vertical components and the horizontal components together forming storage spaces for receiving pallets. The system can include thermal and moisture barriers applied to penetration regions between the refrigeration components and the roof.

Various embodiments of the pallet racking support system can include the pallet rack support system located within the refrigerated facility. In some embodiments, the system can include the pallet rack support system supporting the weight of the refrigerated components positioned on a roof of the refrigerated facility. In some examples, the system can include the pallet rack support system supporting a static load of the refrigerated components positioned on a roof of the refrigerated facility. The system can include the pallet rack support system configured to accommodate additional weight from the refrigeration components. The system can include the vertical components coupled to the refrigeration components through an upper terminus of the vertical components. The system can include the vertical components having vertical beams. The system can include the horizontal components having horizontal shelves. The system can include the vertical and/or horizontal components including steel, e.g., steel vertical and/or steel horizontal components. The system can include the vertical components including at least one of tubular steel, angular steel, and/or structural steel.

A method for manufacturing a pallet racking support system is presented. In some embodiments, the method can include providing refrigerated facility information. In some examples, the method can include preparing refrigeration components based on the refrigerated facility information. The method can include preparing pallet racking configuration and pallets based on the refrigeration facility information. The method can include preparing engineering specifications based on the refrigerated facility information. The method can include forming vertical components and horizontal components of the pallet racking support system based on the engineering specifications. The method can include transporting the vertical components and horizontal components of the pallet racking support system to the refrigerated facility.

Various embodiments of the method for manufacturing a pallet racking support system can include transporting the refrigerated components to the refrigerated facility. In some embodiments, the refrigerated facility information includes at least one of: an area of the refrigerated facility, a volume of the refrigerated facility, a height of the refrigerated facility, a structural configuration of the refrigerated facility, a pallet racking configuration of the refrigerated facility, a storage capacity of the refrigerated facility, a weight of refrigeration components, an interior temperature targets of the refrigerated facility, and/or a location of refrigerated components within the refrigerated facility. In some examples, the method can include determining a number of pallets to be used based on the refrigerated facility information. The method can include forming the vertical components and horizontal components at an offsite facility.

A method of installing a pallet racking support system is presented. In some embodiments, the method can include analyzing a foundation of a refrigerated facility. In some examples, the method can include coupling vertical components to the foundation of the refrigerated facility based on the analysis of the foundation. The method can include coupling an upper terminus of the vertical components to the refrigerated facility. The method can include coupling horizontal components to the vertical components. The method can include installing thermal and moisture barriers at roof penetration regions. The method can include installing mounting brackets to the upper terminus of the vertical components.

Various embodiments of the method for installing a pallet racking support system can include performing load testing and performing certification of the pallet racking support system. In some embodiments, coupling vertical components and horizontal components includes coupling vertical beams to the foundation of the refrigerated facility, and coupling horizontal shelves to the vertical beams. In some examples, the method can include determining a loading capacity of the refrigerated facility. The method can include reinforcing the foundation of the refrigerated facility based on the loading capacity.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the systems and methods described herein. In the following description, various embodiments are described with reference to the following drawings.

FIG. 1 illustrates a refrigerated facility including roof positioned refrigeration components, according to some embodiments.

FIG. 2 illustrates a pallet racking support system, according to some embodiments.

FIG. 3 illustrates a flowchart for a method of manufacturing a pallet racking support system, according to some embodiments.

FIG. 4 illustrates a flowchart method for installing of a pallet racking support system, according to some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

The present disclosure generally relates to systems and methods for pallet racking support for refrigerated facilities.

Pallet racking systems are used to hold the weight of stored pallets in warehouses. The pallets are placed and retrieved from the pallet racking system within the warehouse using material handling equipment such as fork-lifts. Pallet racking systems can include structural steel, and be installed in vertical beams with horizontal shelves. Refrigerated facilities, e.g., temperature controlled warehouses, can make use of large refrigeration systems that can include refrigeration components positioned on the roof of the refrigerated facility, and/or positioned at a substantial height of within the building of the refrigerated facility itself. Since these refrigeration components can include static loads and/or have a large amount of weight, a substantial amount of structural reinforcement in the frame and roof of the refrigerated facility can be implemented to support the refrigeration components. Thus, refrigerated facilities can necessitate substantial structural reinforcement to support the weight of roof-mounted refrigeration equipment. In some embodiments, the systems and methods presented herein provide pallet racking support systems used within the refrigerated facilities that allow for efficiently supporting refrigeration components to substantially reduce using additional structural reinforcements, and/or eliminate the need for the additional structural reinforcements used in the refrigerated facility's frame and/or roof.

As described herein, the term facility can be used to describe a refrigerated facility, a refrigerated warehouse, a warehouse, and these terms can be used interchangeably.

### Pallet Racking and Refrigerated Systems

Pallet racking systems are used in refrigerated facilities to shelve pallets vertically and horizontally within the warehouse space. Pallet racking systems can be made of structural steel, and include vertical beams with horizontal shelves that are used to hold the weight of the stored pallets and their corresponding loads, e.g., considering a safety weight margin. Pallets can be placed and retrieved in the racking system using material handling equipment such as fork-lifts. Pallet racking can also be an integrated component of a robotic system that places and retrieves the pallets within refrigerated facilities.

Refrigerated facilities can make use of large refrigeration systems that generally include both refrigeration and air handling components. These components may be positioned on the roof of the facility, or positioned at an elevated location on the building, to allow cold air to be blown downward into the facility space. Locating the refrigeration systems on the roof or at elevated areas of the facility can be more energy efficient in comparison to cooling from the ground up. The refrigeration components can include substantial static loads (e.g., be substantially heavy and/or include substantial weight). Thus, refrigerated facilities that include roof positioned refrigeration systems can benefit from additional structural reinforcement in the frame and roof of the facility, as compared to cold storage facilities with ground positioned refrigeration systems or non-refrigerated warehouses.

Refrigerated facilities can make use of one or more cooling techniques for cooling stored products, e.g., food, foodstuff, among other stored items. The cooling techniques can be implemented via the refrigeration and/or air handling components. Certain cooling techniques commonly require the use of roof mounted refrigeration equipment. These cooling techniques can include blast freezing, blast chilling, temping, among other cooling techniques. Exemplary cooling techniques are described below.

Convective air blast freezing is a process of moving large volumes of refrigerated air over the stored products to freeze the stored products as quickly as possible. Blast freezing is performed on stored products (e.g., including perishable products) inside specialized refrigerated facilities. These refrigerated facilities can be equipped with blast freezers, e.g., blast freezers can be used to perform the blast freezing. During the blast freezing process, individual cases and/or items of stored products can be separated to provide air flow between each case or item that are stacked onto pallets. Separating the cases and/or items in this way can allow for air to flow around the cases or items that can be stacked in several layers of pallets. During blast freezing, refrigerated air is blown over the stored product using fans to rapidly remove heat and freeze the stored product. The frozen temperature range used for blast freezing can vary from product to product. In some examples, the frozen temperature can include temperatures below approximately 32 degrees Fahrenheit, e.g., approximately 0 degrees Celsius, and can reach a range of approximately −10 to −20 degrees Fahrenheit, e.g., approximately −23 to −29 degrees Celsius.

Convective air blast chilling is a process of moving large volumes of refrigerated air over a fresh, ambient temperature stored product to bring the stored product to a chilled temperature range as quickly as possible. The blast chilling process can be substantially the same as blast freezing, e.g., a similar process can be performed but operated in a different temperature range. Blast chilling can be implemented via a blast freezer. Chilled temperature ranges for blast chilling can vary by product. Chilled temperature ranges for blast chilling can include ranges within approximately 32 to 40 degrees Fahrenheit, e.g., 0 to 5 degrees Celsius.

Convective air temping is a process of slowly thawing frozen stored products to a chilled or ambient temperature range by moving large volumes of relatively warmer air over the stored product. Temping can be used on the stored products that are transported in a frozen state but must be thawed for the purposes of further food processing or final distribution. The temping process can force a specific temperature of air over the stored product to gradually bring the stored product from a frozen state to a chilled state without damaging the product itself. Blast freezers, e.g., described above, can be used to perform air temping.

The systems and methods for pallet racking support described herein are configured to and/or used, but are not limited, to refrigeration components used for convective air blast freezing, blast chilling, air temping, among other cooling techniques. The systems and methods for pallet rack support are described in detail below.

### Pallet Racking Support Systems

Pallet racking support systems for refrigerated facilities are presented, according to some embodiments. In some embodiments the pallet racking support systems can include vertical racking systems located within an interior of a refrigerated facility. In some examples, the pallet racking support systems can be used to support palletized products and/or loads. The pallet racking support systems can support some and/or all the static loads refrigeration components located within a roof or elevated within the refrigerated facility. In some examples, the pallet racking support systems can support some and/or all static loads of refrigeration components located above ground level of the refrigerated facility. In some examples, the pallet racking support systems can be used to support ducting, fans and/or other components used for handling refrigerated air and refrigerant. In some examples, the pallet racking systems can support the roof structure of the refrigerated facility along with the refrigeration components and/or equipment located on the roof.

In some embodiments, the pallet racking support systems can reduce and/or eliminate using additional structural components imbedded into the refrigerated facility itself by supporting the roof positioned refrigeration components from an interior of the refrigerated facility. The pallet racking support systems having rack supported refrigeration equipment can reduce the amount of structural steel used in refrigerated facility construction, e.g., in comparison to a refrigerated facility that relies on additional structural steel in the shell of the facility. Additionally, pallet rack support of refrigeration systems can simplify the modification of existing facilities with added refrigeration capacity, by eliminating and/or reducing the need for structural reinforcement of those facilities at the time of installation. Unlike traditional refrigerated warehouses that can necessitate substantial structural reinforcement to support the static load of roof-mounted refrigeration equipment, the pallet racking support system supports palletized products within the facility, and while efficiently bearing the static load of roof-based and/or substantially elevated refrigeration components.

In some embodiments, the refrigeration system components can be mounted directly and/or indirectly to the pallet racking support system. In some examples, the refrigeration system components can be mounted directly to the facility roof structure, which can be supported entirely and/or partially by the vertical components and horizontal components of the pallet racking support system. The vertical components can include vertical beams, and the horizontal components can include horizontal shelves, among other components. The vertical components can extend from the facility floor to the roof and support the weight of refrigeration equipment, ducting, fans, and other facility components. The configuration presented herein further facilitates the modification of existing facilities, streamlining the addition of refrigeration capacity without extensive structural alterations. The configuration for the vertical and horizontal components can be constructed from a tubular, angular, and/or other structural steel. Furthermore, the pallet racking support system can incorporate a mounting system for securing the refrigeration components to a roof, floor, and/or foundation of the refrigerated facility. In some embodiments, a reinforced floor and/or foundation of the refrigerated facility can be installed and/or used to support the pallet racking support system. In some examples, the floor and/or foundation of a refrigerated facility can be analyzed to determine a load capacity of the refrigerated facility. The analysis of the loading capacity can be used to determine whether the floor and/or foundation of the refrigerated facility is structurally stable enough to support and/or maintain a combined weight of the pallet racking system, refrigeration equipment, and potential load placed on the pallets. In one example, provided the analysis of the loading capacity determines the floor and/or foundation can benefit from reinforcement to support the pallet racking support system, the floor and/or foundation of the refrigerated facility can be reinforced by installing pillars and/or increasing the foundation depth to prevent settling that could lead to cracking of the floors and/or foundation.

The pallet racking support system can be used with refrigeration systems that are configured to, and/or used to, perform air blast freezing, blast chilling, and temping, among other chilling techniques. The method of manufacturing the pallet racking support system can include preparing the components of the pallet racking system offsite, with components of the pallet racking system transported for on-site installation. The pallet racking support system installation process can include coupling the vertical components to the refrigerated facility floor, coupling horizontal components to the vertical components, penetrating the roof for upper terminus support of the vertical components, and mounting and/or securing all components together to form the pallet racking support system. Thermal and moisture barriers can be implemented and/or installed at the refrigerated facility to maintain the interior temperature environment of the facility. Load testing can be performed to ensure compliance with one or more safety regulations.

The structural pallet racking system can include a mounting system for connecting refrigeration components, and a system of thermal and moisture barriers. This structural pallet racking system for refrigeration systems can allow for enhanced cost-effective construction of new refrigerated facilities, and can simplify the modification of existing refrigerated, providing a versatile solution for efficient and structurally sound refrigeration support.

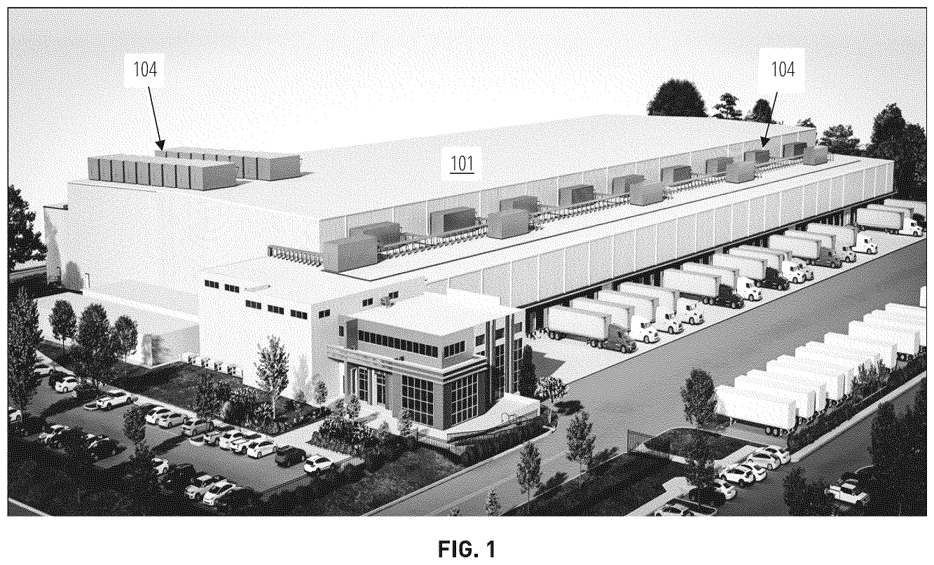

Referring to FIG. 1, a refrigerated facility including roof positioned refrigeration components is shown, according to some embodiments. The refrigerated facility 101 can include refrigeration components 104 that can include structural mounts and/or air handling components. The refrigeration components 104 can be located on a roof of the refrigerated facility 101 as shown. Alternative to that shown, the refrigeration components 104 can be located on a substantially elevated area of the refrigerated facility 101, e.g., aside from the roof. The refrigeration components 104 can have a substantial static load and/or weight. As described herein, the refrigeration components 104 can also be referred to as refrigeration equipment, among other terms.

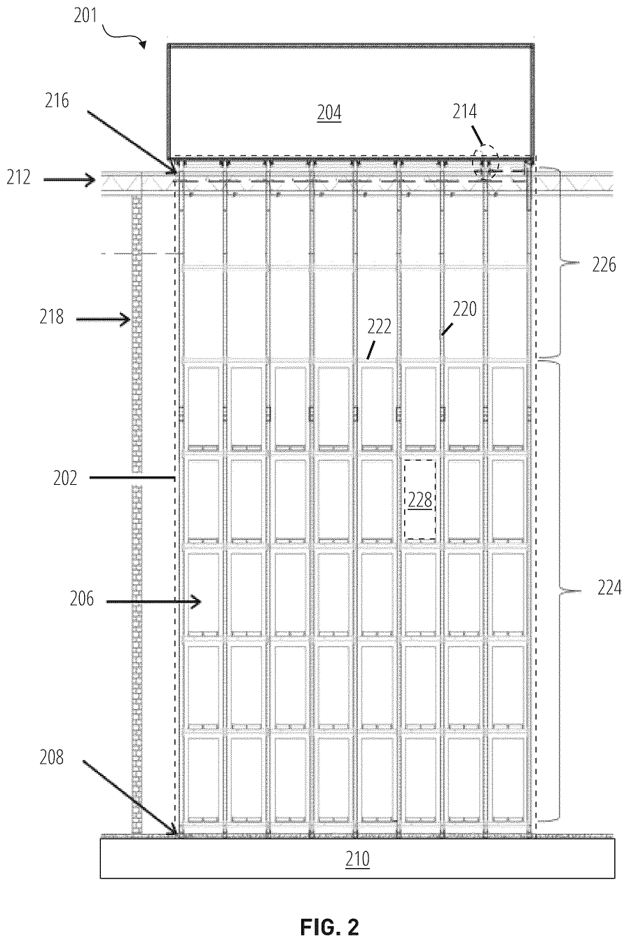

Referring to FIG. 2, a pallet racking support system for a refrigerated facility 201 is shown in cross section including the refrigerated facility 201, according to some embodiments. In some embodiments, the pallet racking support system 202 is located within the refrigerated facility 201. In some examples, the pallet racking support system 202 can be configured to, and/or used to, support the static loads, e.g., weight, of the refrigeration components 204 and hold pallets 206. The pallet racking support system 202 can be fixed to a floor 208 and/or a floor and/or foundation 210 of the refrigerated facility 201. In some examples, the pallet racking support system 202 can be permanently affixed to the floor 208. In some examples, the floor 208 and the foundation 210 can be reinforced to support the weight of the pallet racking support system 202, refrigeration components 204, and potential weight of the pallets 206. The pallet racking support system 202 can extend upwards through a roof 212 of the refrigerated facility 201. In some embodiments, the pallet racking support system 202 can extend upwards to the lower edge of the roof 212, e.g., supporting some and/or all the weight of the roof 212 and refrigeration components 204. The pallet racking support system 202 can be fixed to the refrigeration components 204, supporting some and/or all the weight of the refrigeration components 204. In some examples, the pallet racking support system 202 can be permanently affixed to the floor 208 and/or the refrigeration components 204 to support some and/or all the weight of the refrigeration components 204. The pallet racking support system 202 can be connected to the refrigeration components 204 via an upper terminus 214 of the pallet racking support system 202. The roof 212 may or may not be supported by a frame structure 218 and/or wall of the refrigerated facility 201.

Referring again to FIG. 2, according to some embodiments, the pallet racking support system 202 presented herein is an integrated system in a tower configuration. In some examples, the presented configuration for the pallet racking support system 202 can be opposed to other systems that are a collection of separate components which are spread around the refrigerated facility in separated rooms. In some examples, the pallet racking support system improves energy efficiency by concentrating cooled air within the confines of the pallet racking support system 202 as compared to cooling an entire room. In some examples, the pallet racking support system 202 improves operational efficiency of cooling stored products within the refrigerated facility 201 by performing blast freezing, blast chilling and/or convective air temping on multiple stored products stacked onto the pallets 206 altogether at a single time. For example, performing the blast freezing, and/or blast chilling using the pallet racking support system 202 can more efficiently allow for cold air to flow around multiple stored products over a substantially larger area and/or footprint of the refrigerated facility 201, e.g., as opposed to others systems that perform blast freezing and/or blast chilling using individual, e.g., separate, blast freezer rooms that are spread around the refrigerated facility. In one example, performing convective air temping using the pallet racking support system 202 can more efficiently allow for moving large volumes of relatively warmer air to flow around stored product over a substantially larger area and/or footprint of the refrigerated facility 201, e.g., as opposed to others systems that perform convective air temping using individual, e.g., separate, blast freezer rooms.

Referring again to FIG. 2, according to some embodiments, the pallet racking support system 202 can be made up of vertical components 220 and horizontal components 222. The vertical components 220 can include vertical beams. The horizontal components 222 can include horizontal shelves. The vertical components 220 and horizontal components 222 can be connected together and form levels 224 which can be configured to, and/or used to, to support and hold the pallets 206. In some embodiments, the vertical components 220 and/or the horizontal components 222 can be made from tubular, angular, and/or other structural steel. The vertical components 220 can form vertical structural elements 226 that provide structural support to the refrigeration components 204. In some examples, the vertical components 220 can be coupled to and/or connected with the horizontal components 222 to form the vertical structural elements 226. In some embodiments, the vertical components 220 and the horizontal components 222 can be configured to, and/or used to, hold the pallets 206 and extend the pallet racking support system 202 up to and through the roof 212. The vertical components 220 can be connected to the refrigeration components 204 via the upper terminus 214 of the vertical components 220. In some embodiments, mounting brackets can be used to join the vertical components 220 and the refrigeration components 204 together, e.g., the vertical components 220 and the refrigeration components 204 can be joined together at the upper terminus 214. In some examples, the mounting brackets can be installed, mounted and/or attached at the upper terminus to join the vertical components 220 and refrigeration components 204 together. The vertical components 220 can include mounting brackets at the upper terminus 214 for supporting the refrigeration components 204. In some examples, thermal and moisture barrier and/or seals 216 can be applied and/or used at penetration regions of the refrigerated facility 201 where the pallet racking support system 202 penetrates the roof 212. In some examples, the penetration regions are located between the refrigeration components 204 and the roof 212. In some embodiments, the vertical components 220 and the horizontal components 222 together can form storage spaces 228 for receiving and/or placement of the pallets 206.

### Methods for Manufacturing Pallet Racking Support Systems

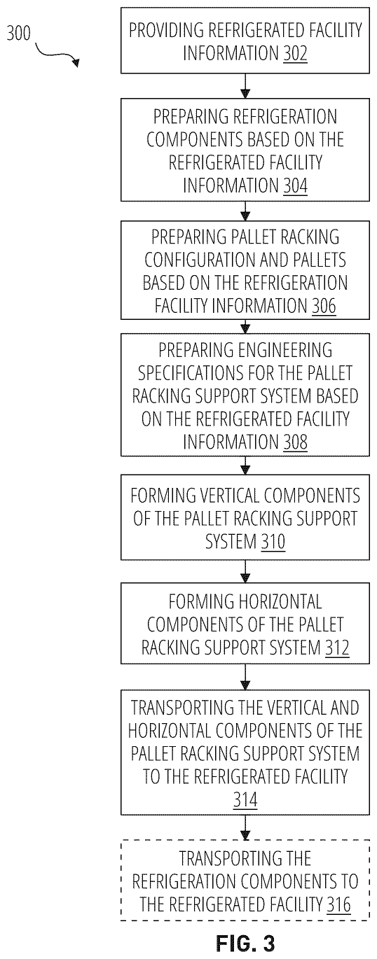

Referring to FIG. 3, a methods for the manufacturing a pallet racking support system 300 is shown, according to some embodiments. At step 302, the method can include providing refrigerated facility information 302. The refrigerated facility information can include the area, volume, height, and/or structural configuration of the refrigerated facility. In some examples, the refrigerated facility information can include a projected area of the pallet racking support system and/or an actual area of the pallet racking support system once installed. The refrigerated facility information can include pallet racking configuration, and storage capacity for the refrigerated facility. The refrigerated facility information can include weight, and/or a location of refrigeration components, e.g., how much each refrigeration component weighs and/or where each refrigeration component is going to be placed on and/or within the refrigerated facility. The refrigerated facility information can include interior temperature targets of the refrigerated facility. In some examples, the interior temperature targets can include an optimal temperature range for preserving, and/or maintaining a particular product. The refrigerated facility information can be based on a new, e.g., newly built or to be built, refrigerated facility. The refrigerated facility information can be based on an existing, e.g., already built and/or pre-built, refrigerated facility. At a step 304, the method can include preparing refrigeration components based on the refrigerated facility information 304. The refrigerated components can be configured and/or to be positioned on a roof or above ground level of the refrigerated facility. At a step 306, the method can include preparing pallet racking configuration and pallets based on the refrigeration facility information 306. Preparing the pallet racking configuration and pallets can be based on a storage capacity defined by the refrigerated facility information. Preparing pallet racking configuration and pallets can include determining the number of pallets to be used based on the pallet racking configuration based on the refrigerated facility information. At a step 308, the method can include preparing engineering specifications for the pallet racking support system based on the refrigerated facility information 308. The engineering specifications can be based on load and/or dimensions defined from the refrigerated facility information. At a step 310, the method can include forming vertical components of the pallet racking support system 310. Forming the vertical components can be based on the engineering specifications and/or refrigerated facility information. The vertical components can include vertical beams, among other structural elements. Forming the vertical components can include forming the vertical components at an offsite manufacturing facility. At a step 312, the method can include forming horizontal components of the pallet racking support system 312. Forming the horizontal components can be based on the engineering specifications and/or refrigerated facility information. The horizontal components can include horizontal shelves, among other structural elements. Forming the horizontal components can include forming the horizontal components at the offsite manufacturing facility. At step 314, the method can include transporting the vertical and horizontal components of the pallet racking support system to the refrigerated facility 314. At an optional step 316, the method can include transporting the refrigeration components to the refrigerated facility 316.

### Methods for Installing Pallet Racking Support System

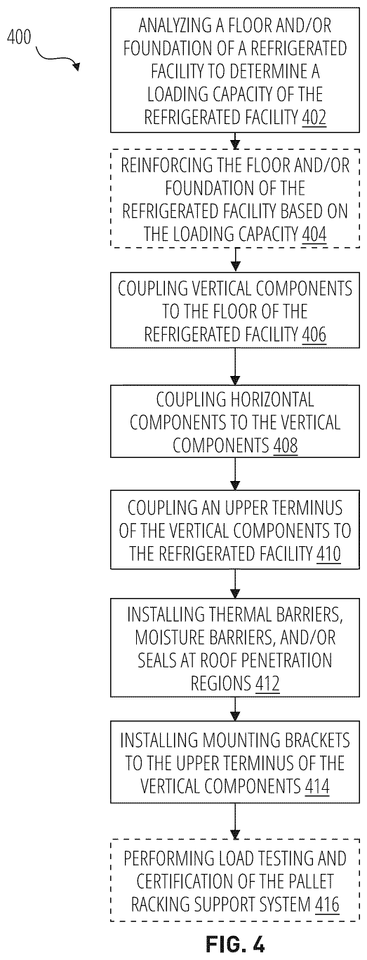

Referring to FIG. 4, a method for installing a pallet racking support system 400 is shown, according to some embodiments. At step 402, the method includes analyzing a floor and/or foundation of a refrigerated facility to determine a loading capacity of the refrigerated facility 402. Determining the loading capacity can including determining whether the floor and/or foundation of the refrigerated facility is structurally stable enough to support and/or maintain a combined weight of the pallet racking system, refrigeration equipment, and potential load placed on the pallets. At an optional step 404, the method includes reinforcing the floor and/or foundation of the refrigerated facility based on the loading capacity 404. In some embodiments, reinforcing the floor and/or foundation can include installing pillars and/or increasing the foundation depth to prevent settling that could lead to cracking of the floors and/or foundation. In some examples, step 404 may not be performed provided the loading capacity is determined to be structurally stable enough to support the pallet racking system, refrigeration equipment, and potential load placed on the pallets. At step 406, the method includes coupling vertical components to the floor of the refrigerated facility 406. The vertical components can include vertical beams. Coupling the vertical components can include positioning the vertical components standing upright, e.g., vertically, with respect to the refrigerated facility. At step 408, the method can include coupling horizontal components to the vertical components 408. The horizontal components can include horizontal shelves. Coupling the horizontal components can include connecting the horizontal components with the vertical components to form storage spaces and/or shelve spaces that can house pallets. In some embodiments, the vertical and horizontal components can be made from tubular, angular, and/or other structural steel. In some examples, the vertical and horizontal components can be made from some other structural material. At step 410, the method can include coupling an upper terminus of the vertical components to the refrigerated facility 410. Coupling the upper terminus of the vertical components to the refrigerated facility can include penetrating the roof of the refrigerated facility with the upper terminus of the vertical components. The upper terminus can be connected to the refrigerated facility at roof penetration regions. Coupling the horizontal components to the vertical components at step 408 can include connecting the horizontal components with the vertical components to provide lateral stability to the pallet racking support system, e.g., before the roof is penetrated at step 410, to accommodate the upper terminus of the vertical components. At step 412, the method can include installing thermal barriers, moisture barriers, and/or seals at roof penetration regions 412. Installing thermal barrier, moisture barriers, and/or seals can provide thermal insulation and/or preserve the interior environment of the refrigerated facility. At step 414, the method can include installing mounting brackets to the upper terminus of the vertical components 414. Installing mounting brackets allows for mounting the refrigeration components to the refrigerated facility. At an optional step 414, the method can include performing load testing and certification of the pallet racking support system 416. Load testing and performing certification can be performed to determine that the pallet racking system complies with applicable safety regulations for the region in which the corresponding refrigerated facility is located. The safety regulations can include, but are not limited to, the American National Standards Institute (ANSI) and the Rack Manufacturing Institute (RMI) building codes, definitions, and specifications. Applicable foundation adequacy and specifications can be based on Federal Emergency Management Administration criteria 460 (FEMA 460) Seismic Considerations For Steel Storage Racks Located In Areas Accessible To The Public.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A pallet racking support system, the system compromising:
refrigeration components located on a roof of a refrigerated facility;
vertical components coupled to a floor of the refrigerated facility, wherein the vertical components extend through the roof of the refrigerated facility to couple to the refrigeration components;
horizontal components coupled to the vertical components, the vertical components and the horizontal components together forming storage spaces for receiving pallets; and
thermal and moisture barriers applied to penetration regions between the refrigeration components and the roof.

2. The pallet rack support system of claim 1, wherein the pallet rack support system is located within the refrigerated facility.

3. The pallet rack support system of claim 1, wherein the pallet rack support system supports the weight of the refrigerated components positioned on a roof of the refrigerated facility.

4. The pallet rack support system of claim 1, wherein the pallet rack support system supports a static load of the refrigerated components positioned on a roof of the refrigerated facility.

5. The pallet rack support system of claim 1, wherein the pallet rack support system is configured to accommodate additional weight from the refrigeration components.

6. The pallet rack support system of claim 1, wherein the vertical components are coupled to the refrigeration components through an upper terminus of the vertical components.

7. The pallet rack support system of claim 1, wherein the vertical components comprise vertical beams.

8. The pallet rack support system of claim 1, wherein the horizontal components comprise horizontal shelves.

9. The pallet rack support system of claim 1, wherein the vertical components comprise steel.

10. The pallet rack support system of claim 1, wherein the vertical components comprise at least one of tubular steel, angular steel, or structural steel.

11. The pallet rack support system of claim 1, wherein the horizontal components comprise steel.

12. A method for manufacturing a pallet racking support system, the method comprising:
providing refrigerated facility information;
preparing refrigeration components based on the refrigerated facility information;
preparing pallet racking configuration and pallets based on the refrigeration facility information;
preparing engineering specifications based on the refrigerated facility information;
forming vertical components and horizontal components of the pallet racking support system based on the engineering specifications; and
transporting the vertical components and horizontal components of the pallet racking support system to the refrigerated facility.

13. The method of claim 12, further comprising transporting the refrigerated components to the refrigerated facility.

14. The method of claim 12, wherein the refrigerated facility information comprises at least one of an area of the refrigerated facility, a volume of the refrigerated facility, a height of the refrigerated facility, a structural configuration of the refrigerated facility, a pallet racking configuration of the refrigerated facility, a storage capacity of the refrigerated facility, a weight of refrigeration components, an interior temperature targets of the refrigerated facility, or a location of refrigerated components within the refrigerated facility.

15. The method of claim 12, wherein preparing the pallet racking configuration comprises determining a number of pallets to be used based on the refrigerated facility information.

16. The method of claim 12, wherein forming vertical components and horizontal components of the pallet racking support system comprises forming vertical components and horizontal components at an offsite facility.

17. A method of installing a pallet racking support system, the method comprising:
analyzing a foundation of a refrigerated facility;
coupling vertical components to the foundation of the refrigerated facility based on the analysis of the foundation;
coupling horizontal components to the vertical components;
coupling an upper terminus of the vertical components to the refrigerated facility;
installing thermal and moisture barriers at roof penetration regions; and
installing mounting brackets to the upper terminus of the vertical components.

18. The method of claim 17, further comprising performing load testing and performing certification of the pallet racking support system.

19. The method of claim 17, wherein coupling vertical components and horizontal components comprises:
coupling vertical beams to the foundation of the refrigerated facility; and
coupling horizontal shelves to the vertical beams.

20. The method of claim 17, wherein analyzing a foundation of a refrigerated facility comprises determining a loading capacity of the refrigerated facility.

21. The method of claim 20 further comprising:
reinforcing the foundation of the refrigerated facility based on the loading capacity.
